(19) United States
(12) Patent Application Publication
(10) Pub. No.: US 2021/0034051 A1
(43) Pub. Date: Feb. 4, 2021

(54) VEHICLE OPERATION SYSTEM

(71) Applicant: TOYOTA JIDOSHA KABUSHIKI KAISHA, Toyota-shi (JP)

(72) Inventors: Miyako HAYASHIDA, Miyoshi-shi (JP); Toshinari OGAWA, Nagoya-shi (JP); Kosuke FUJIMOTO, Nisshin-shi (JP); Hideo HASEGAWA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/929,695

(22) Filed: Jul. 15, 2020

(30) Foreign Application Priority Data
Jul. 30, 2019 (JP) 2019-139984

(51) Int. Cl. G05D 1/00; B60K 35/00

(52) U.S. Cl. CPC G05D 1/0027; G02B 27/0101; B60K 2370/334; B60K 35/00

(57) ABSTRACT

A vehicle operation system includes: a first vehicle in which an occupant boards; and a second vehicle configured to be loaded on or towed by the first vehicle and supports plural kinds of work, the second vehicle being remotely operable by remote operation by the occupant using an operation interface of the first vehicle.

### CROSS-REFERENCE TO RELATED APPLICATION

This application claims priority under 35 USC 119 from Japanese Patent Application No. 2019-139984, filed on Jul. 30, 2019, the disclosure of which is incorporated by reference herein.

### BACKGROUND

### Technical Field

The present disclosure relates to a vehicle operation system.

### Related Art

Japanese Patent Application Laid-Open (JP-A) No. 2013-87419 discloses a technology relating to a sign device. The sign device has a warning display surface, a driving section, and a control section. This sign device can move to a predetermined position by the control of the driving means by the control means. In other words, a wheeled work support vehicle includes the sign device. Therefore, the sign can be arranged at a construction site on a road or at a site where a traffic accident occurs, without depending on the arrangement work of the worker. For this reason, signs can be safely and quickly arranged.

However, in the case of the configuration disclosed in JP-A No. 2013-87419, the control section controls the driving section using an ultrasonic sensor or a GPS receiver. For this reason, there is a possibility that the work support vehicle having the sign device cannot be appropriately arranged according to the state of the site, such as the road that changes from moment to moment. On the other hand, when the worker manually places the sign device, it can be appropriately arranged depending on the situation, but the work of the worker at a specific place such as an expressway involves high risk, and personnel such as traffic guards are required in order to work safely. Thus, there is scope for improvement of the conventional technology described above in regard to these problems.

### SUMMARY

The present disclosure provides a vehicle operation system that may appropriately position a work support vehicle without manual intervention even under a complicated situation.

A first aspect of the present disclosure is a vehicle operation system, including two different vehicles, a first vehicle in which an occupant boards, and a second vehicle. The second vehicle can be loaded on or towed by the first vehicle and supports various kinds of work. The second vehicle is remotely operable by remote operation by the occupant using an operation interface of the first vehicle.

According to the first aspect of the present disclosure, the second vehicle, which can be loaded on or towed by the first vehicle and which supports various kinds of work, can be operated by an occupant who is boarded on the first vehicle by remote control. Therefore, after moving with the first vehicle to a site where work is required, it is easy for the occupant of the first vehicle to appropriately operate the second vehicle according to the situation of the site without getting off the first vehicle. That is, there is no need for the occupant to get off at a high risk place such as on a highway. Further, this remote operation is performed using an operation interface of the first vehicle. Therefore, the occupant may remotely operate the second vehicle from the first vehicle without a sense of discomfort. Accordingly, the first aspect may appropriately operate the second vehicle.

According to a second aspect of the present disclosure, in the first aspect, the second vehicle may include an image capturing device configured to image vehicle surroundings of the second vehicle; and the first vehicle may include a display device configured to display an image imaged by the image capturing device at a front windshield glass.

According to the second aspect of the present disclosure, the second vehicle is provided with an image capturing device. The image capturing device can image the vehicle surrounding of the second vehicle. An image imaged by the image capturing device can be displayed on the front windshield glass of the first vehicle by the display device provided at the first vehicle. Therefore, the occupant can remotely operate the second vehicle by the operation interface of the first vehicle in the same posture as when driving the first vehicle. Therefore, according to the second aspect, cooperation between the driving of the first vehicle and the remote operation of the second vehicle may be smoothly performed.

According to a third aspect of the present disclosure, in the second aspect, the image displayed at the display device may be displayed to coincide with a line-of-sight when viewing surroundings from a vehicle interior of the first vehicle through the front windshield glass.

Further, according to the third aspect of the present disclosure, an image at the front windshield glass of the first vehicle is displayed to coincide with a line of sight when viewing the vehicle surroundings from the vehicle interior of the first vehicle through the front windshield glass. Accordingly, a sense of discomfort experienced by the occupant between when an image is displayed and when an image is not displayed may be reduced. According to the third aspect, a sense of discomfort when switching from driving the first vehicle to remote operation of the second vehicle may be reduced.

According to a fourth aspect of the present disclosure, in the third aspect, the image capturing device may be positioned at a vehicle vertical direction that corresponds to the front windshield glass of the first vehicle.

According to the fourth aspect of the present disclosure, the image capturing device provided on the second vehicle may be positioned at a position in a vehicle vertical direction that corresponds to the front windshield glass of the first vehicle. Therefore, in a case in which an image from the image capturing device of the second vehicle is displayed on the front windshield glass of the first vehicle, the image is displayed to coincide with a line of sight when viewing the vehicle surroundings from the vehicle interior of the first vehicle through the front windshield glass. For this reason, the fourth aspect may reduce a sense of discomfort during remote operation.

According to a fifth aspect of the present disclosure, in the second aspect to the fourth aspect, the display device may display the image at a side window glass of the first vehicle.

According to the fifth aspect of the present disclosure, the display device displays an image at the side window glass of the first vehicle. By causing an image imaged by the image capturing device to be displayed on the front windshield glass and the side window glass, the occupant performing the remote operation may more widely grasp the vehicle surroundings of the second vehicle.

According to a sixth aspect of the present disclosure, in the second aspect to the fifth aspect, the first vehicle may be configured to detect a line-of-sight of the occupant; and an image corresponding to a line of sight of the occupant detected by the line-of-sight detection device may be displayed at the display device.

According to the sixth aspect of the present disclosure, the first vehicle is provided with a line-of-sight detection device. On the display device, an image corresponding to the position of the line of sight of the occupant, detected by the line-of-sight detection device, is displayed. Accordingly, the sixth aspect of the present disclosure may alleviate a sense of discomfort due to a difference in the position of the line of sight between when the vehicle surroundings of the vehicle are viewed through the front windshield glass from inside the vehicle interior of the first vehicle and when the image is viewed. Therefore, in the sixth aspect of the present disclosure, the occupant may appropriately operate the second vehicle while reducing a sense of discomfort at the time of remote operation.

According to the first aspect, the operation system for a vehicle of the present disclosure may appropriately position a work support vehicle even under a complex situation.

According to the second aspect, the vehicle operation system of the present disclosure may improve workability.

According to the third aspect to the fifth aspect, the vehicle operation systems of the present disclosure may improve operability.

According to the sixth aspect, the vehicle operation system of the present disclosure may easily grasp the situation of the vehicle surroundings.

### BRIEF DESCRIPTION OF THE DRAWINGS

Exemplary embodiments will be described in detail based on the following figures, wherein:

FIG. 1 is a schematic drawing illustrating an outline of a vehicle operation system according to an exemplary embodiment;

FIG. 2 is a schematic drawing illustrating a state of a second vehicle of the vehicle operation system according to the first exemplary embodiment, at the time of remote operation;

FIG. 3 is a schematic diagram of the state of a second vehicle of the vehicle operation system according to the first exemplary embodiment, at the time of remote operation as seen from outside the vehicle;

FIG. 4 is a schematic diagram illustrating a state in which the outside of the vehicle is viewed from inside the first vehicle in the vehicle operation system according to the first exemplary embodiment;

FIG. 5 is a schematic diagram illustrating an image on a display device at the time of remote operation of a second vehicle in the vehicle operation system according to the first exemplary embodiment;

FIG. 6 is a block diagram illustrating a hardware configuration of the first vehicle in the vehicle operation system according to the first exemplary embodiment;

FIG. 7 is a block diagram illustrating a hardware configuration of a second vehicle in the vehicle operation system according to the first exemplary embodiment;

FIG. 8 is a block diagram illustrating a hardware configuration of a server in the vehicle operation system according to the first exemplary embodiment;

FIG. 9 is a block diagram illustrating a functional configuration of a vehicle operation system according to the first exemplary embodiment;

FIG. 10 is a flowchart illustrating a flow of an operation of the vehicle operation system according to the first exemplary embodiment;

FIG. 11 is a schematic diagram illustrating a state in which the outside of the vehicle is viewed from inside the first vehicle in the vehicle operation system according to the second exemplary embodiment;

FIG. 12 is a block diagram illustrating a functional configuration of a vehicle operation system according to the second exemplary embodiment;

FIG. 13 is a flowchart illustrating a flow of an operation of the vehicle operation system according to the second exemplary embodiment;

FIG. 14 is a schematic drawing illustrating an outline of a vehicle operation system according the third an exemplary embodiment;

FIG. 15 is a block diagram illustrating a functional configuration of a vehicle operation system according to the third exemplary embodiment; and

FIG. 16 is a flowchart illustrating a flow of an operation of the vehicle operation system according to the third exemplary embodiment.

### DETAILED DESCRIPTION

### First Exemplary Embodiment

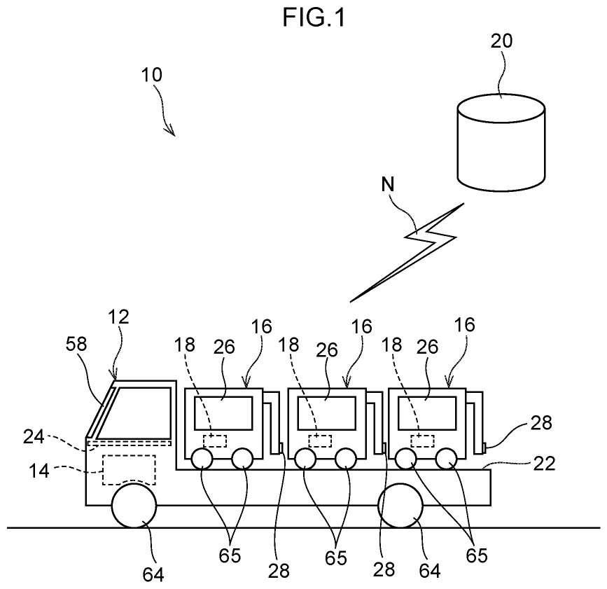

Hereinafter, a first exemplary embodiment of the vehicle operation system 10 according to the present disclosure will be described with reference to FIGS. 1 to 10.

FIG. 1 is a drawing illustrating a schematic configuration of a vehicle operation system according to the first exemplary embodiment.

As illustrated in FIG. 1, the vehicle operation system 10 includes a first vehicle 12, an on-board device 14 mounted on the first vehicle 12, a plurality of second vehicles 16 as work support vehicles, on-board devices 18 mounted on each of the second vehicles 16, and a server 20. These on-board devices 14 and 18 and the server 20 are communicably connected via a network N.

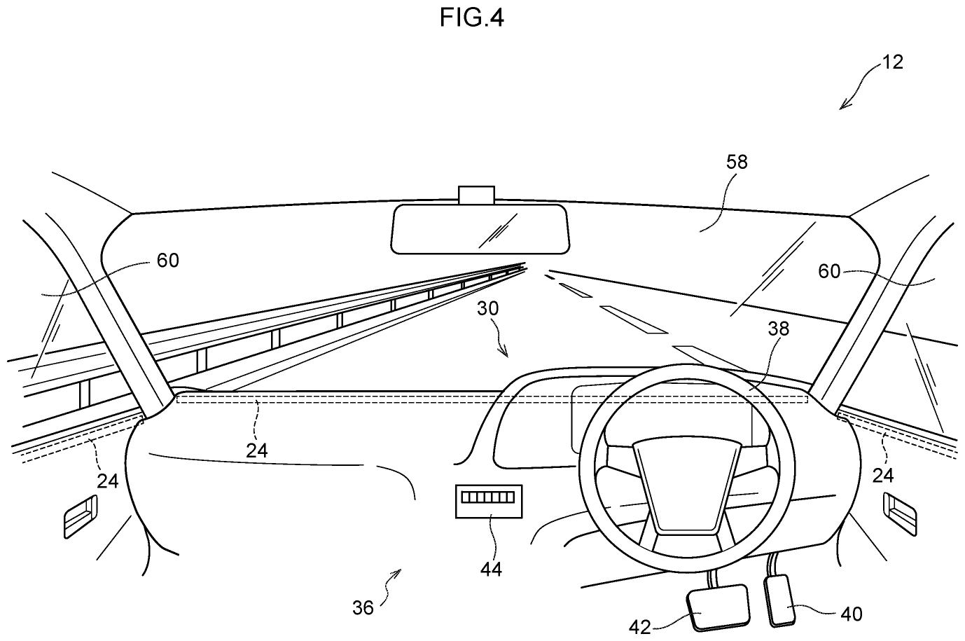

The first vehicle 12 has a cargo bed 22 and a display device 24 as an example. The first vehicle 12 can be mounted with a plurality of second vehicles 16 on the cargo bed 22. The first vehicle 12 is operated by manual driving by an unillustrated occupant who gets into the vehicle interior 36 (see FIG. 4). The specific configuration and operation of the display device 24 will be described later.

The on-board device 14 can transmit operation information of the first vehicle 12 to the server 20 provided outside the vehicle. The specific configuration and operation of the on-board device 14 will be described later.

The second vehicle 16 is, for example, a small vehicle including a sign device 26 and an image capture device 28. The second vehicle 16 is mounted on the first vehicle 12 up to the work site, and upon arrival at the work site, the second vehicle 16 is unloaded from the first vehicle 12 and remotely operated by the occupant of the first vehicle 12 at the work site. That is, in the present exemplary embodiment, the second vehicle 16 is a work support vehicle having a sign function. Specific configurations and operations of the sign device 26 and the image capture device 28 will be described later.

The on-board device 18 transmits an image from the image capture device 28 of the second vehicle 16 to the server 20 and acquires remote operation information from the server 20. The specific configuration and operation of the on-board device 18 will be described later. The operation information described above includes the rotation angle of the steering wheel and the amount of depression of the accelerator pedal and the brake pedal for operating each of the first vehicle 12 and the second vehicle 16. Further, the operation information includes vehicle selection information indicating which one of the first vehicle 12 and the second vehicle 16 is to be operated, and sign information for operating the sign device 26 of the second vehicle 16. In addition, of the operation information, information for operating the second vehicle 16 is particularly referred to as remote operation information.

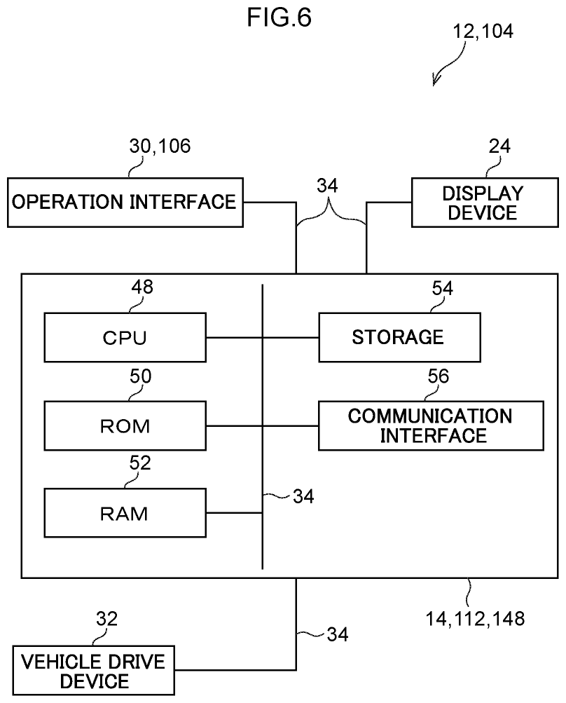

As illustrated in FIG. 6, the first vehicle 12 has an operation interface 30, an on-board device 14, a vehicle driving device 32, and a display device 24. Each of these components is connected together so as to be capable of mutual communication through a bus 34.

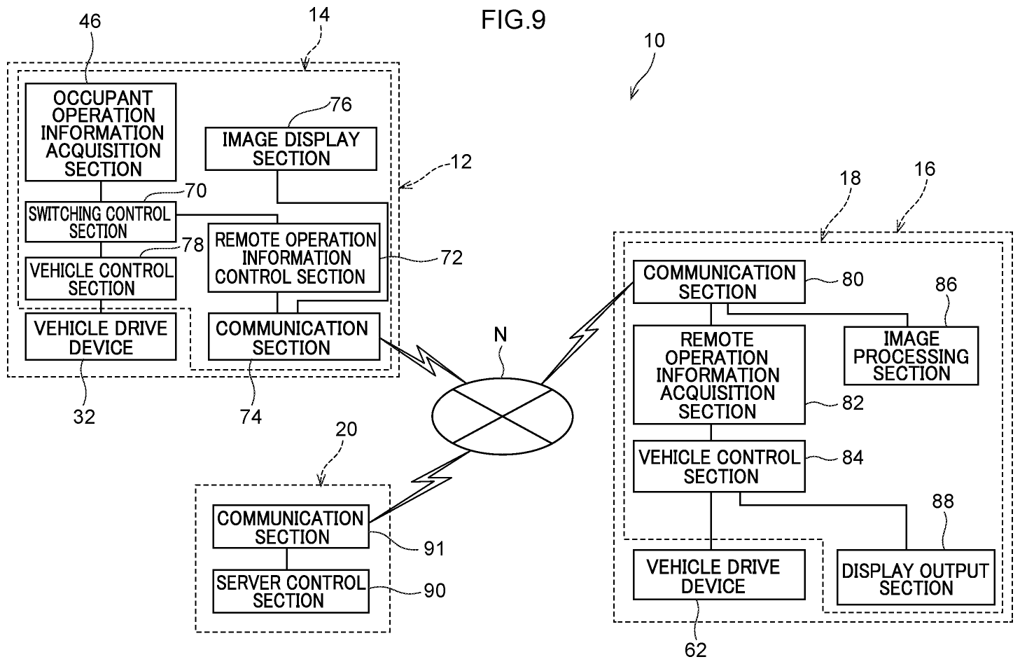

As illustrated in FIG. 4, the operation interface 30 is disposed on the vehicle front side in the vehicle interior 36 of the first vehicle 12. The operation interface 30 includes a steering wheel 38, an accelerator pedal 40, a brake pedal 42, and a sign display operation device 44. The steering wheel 38, the accelerator pedal 40, and the brake pedal 42 in the operation interface 30 are of a so-called drive-by-wire system in which an operation by an occupant is transmitted as an electric signal to a necessary part by a sensor (not illustrated) and a wire harness. The sign display operation device 44 has an operation panel for selecting and displaying images of a plurality of signs that can be displayed on the sign device 26 provided in the second vehicle 16. These operation interfaces 30 are connected to an occupant operation information acquisition section 46 described later in the on-board device 14 (see FIG. 9).

As illustrated in FIG. 6, the on-board device 14 includes a CPU (Central Processing Section) 48, a ROM (Read Only Memory) 50, a RAM (Random Access Memory) 52, a storage 54, and a communication interface 56. Each of these configurations is connected together so as to be capable of mutual communication through a bus 34.

The CPU 48 is a central computation processing section that executes various programs and controls the respective sections. Namely, the CPU 48 reads-out a program from the ROM 50 or the storage 54, and executes the program by using the RAM 52 as a work space. The CPU 48 controls each of the above components and performs various computation processing according to the program recorded in the ROM 50 or the storage 54. In the present exemplary embodiment, the vehicle operation program is stored in the ROM 50 or the storage 54.

The ROM 50 stores various types of programs and various types of data. The RAM 52 acts as a workspace for temporary storage of programs and data. The storage 54 is structured by an HDD (Hard Disk Drive) or an SSD (Solid State Drive), and various types of programs including the operating system, and various types of data are stored therein.

The communication interface 56 is an interface for the on-board device 14 to communicate with the server 20, and utilizes standards such as, for example, the Ethernet, FDDI, Wi-Fi, and the like.

The vehicle drive device 32 activates a motor (not illustrated) that drives the wheels 64 (see FIG. 1) of the first vehicle 12 based on the control of the on-board device 14.

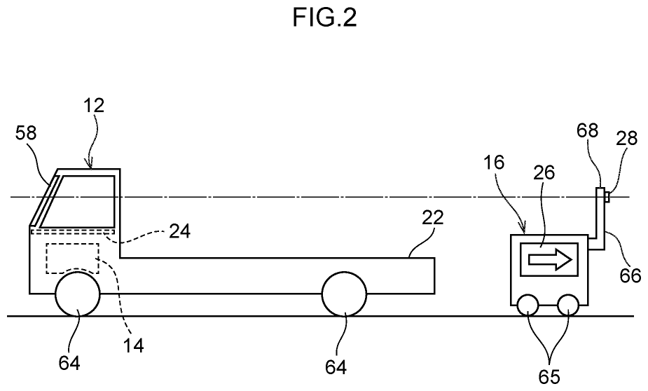

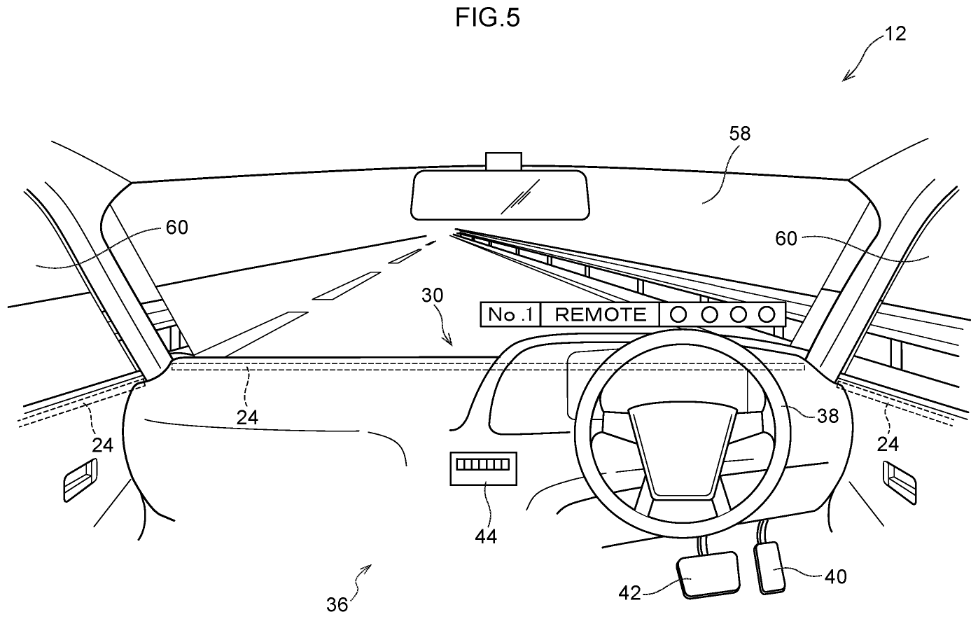

As an example, as illustrated in FIG. 4, the display device 24 is a transparent display provided on the entire surface of each of a front windshield glass 58 and a front side window glass 60 as a pair of left and right side window glasses of the first vehicle 12. The display device 24 is transparent when no image is displayed, and displays an image on the front windshield glass 58 and the front side window glass 60 when the image illustrated in FIG. 5 is displayed. In FIG. 5, as illustrated in FIG. 2, a state in which an image, by the image capture device 28 in a state in which the second vehicle 16 has been unloaded from the first vehicle 12 and is traveling toward the vehicle rear side of the first vehicle 12, is displayed. FIG. 5 also illustrates a portion where no image is displayed on both ends in the vehicle width direction of the front windshield glass 58 and a front end side of the front side window glass 60 in order for it to clearly indicated that the image is being displayed.

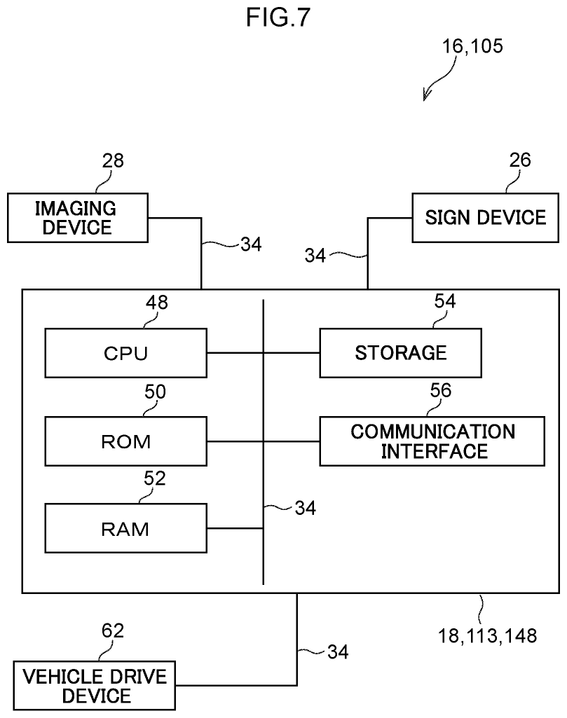

As illustrated in FIG. 7, the second vehicle 16 includes an on-board device 18, a vehicle driving device 62, an image capture device 28, and a sign device 26. As illustrated in FIG. 7, the on-board device 18 includes a CPU 48, a ROM 50, a RAM 52, a storage 54, and a communication interface 56, like the on-board device 14. Each of these components is connected together so as to be capable of mutual communication through a bus 34.

The vehicle drive device 62 activates a motor (not illustrated) that drives the wheels 65 (see FIG. 1) of the second vehicle 16 based on the control of the on-board device 18.

As illustrated in FIG. 2, the image capture device 28 is attached to an end portion 68 of a camera arm 66 attached to a side wall of the second vehicle 16. The camera arm 66 is formed substantially in an L-shape when viewed from the side, and is rotatable around a vehicle front-rear direction as an axial direction by a driving section (not illustrated). Thereby, the end portion 68 can be displaced in the vehicle vertical direction. In the state where the second vehicle 16 of the present exemplary embodiment is on the substantially same plane (road) as the first vehicle 12, the end portion 68 can be disposed in a position substantially corresponding to the center is in the vehicle vertical direction of the front windshield glass 58 of the first vehicle 12 (see the dash-dot-dash line in the figure).

The sign device 26 is attached to a side wall of the second vehicle 16. The sign device 26 includes, for example, a liquid crystal panel.

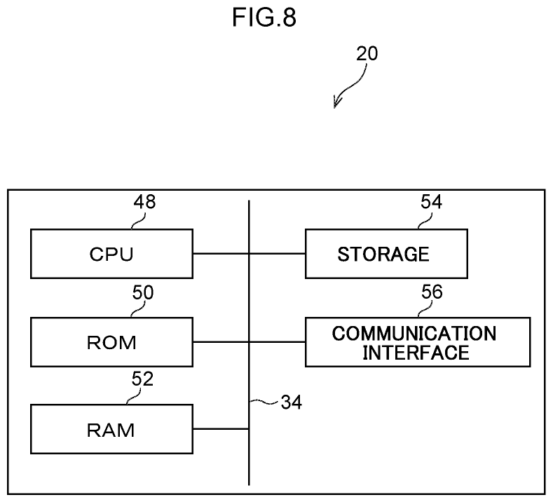

As illustrated in FIG. 8, the server 20 includes a CPU 48, a ROM 50, a RAM 52, a storage 54, and a communication interface 56. Each of these configurations is connected together so as to be capable of mutual communication through a bus 34.

When executing the above-mentioned vehicle operation program, the vehicle operation system 10 realizes various functions using the above-mentioned hardware resources. Explanation follows regarding the functional configurations realized by the vehicle operation system 10.

FIG. 9 is a block diagram illustrating an example of a functional configuration of the vehicle operation system 10.

As illustrated in FIG. 9, the vehicle operation system 10 includes, as functional components in the first vehicle 12, an occupant operation information acquisition section 46, a switching control section 70, a remote operation information control section 72, a vehicle control section 78, a communication section 74 and an image display section 76. Each functional component is implemented by the CPU 48 of the on-board device 14 reading a vehicle operation program stored in the ROM 50 or the storage 54, and executing the program.

The occupant operation information acquisition section 46 obtains operation information input to the operation interface 30 by the occupant of the first vehicle 12.

The switching control section 70 selectively transmits the operation information transmitted from the occupant operation information acquisition section 46 to either the remote operation information control section 72 or the vehicle control section 78. The transmission destination of the operation information is selected according to the vehicle that the occupant wants to operate. In the case of the present exemplary embodiment, it is determined which of the first vehicle 12 and the second vehicle 16 the occupant wishes to operate by the occupant operating a selection button (not illustrated) provided on the operation interface 30. Then, when the occupant operates the first vehicle 12, operation information is sent to the vehicle control section 78. On the other hand, when the occupant operates the second vehicle 16, the operation information is sent to the remote operation information control section 72. In the present exemplary embodiment, it is possible to select which vehicle of the plurality of second vehicles 16 is to be further operated, and the operation information is transmitted to the vehicle in accordance with the selection.

The vehicle control section 78 controls the driving of the vehicle drive device 32 based on the various information acquired by the occupant operation information acquisition section 46.

The remote operation information control section 72 acquires the operation information from the occupant operation information acquisition section 46 and controls the communication section 74 so as to transmit the operation information to the server 20.

The communication section 74 transmits and receives information to and from another device.

The image display section 76 controls the communication section 74 so as to obtain the image transmitted from the second vehicle 16 via the server 20, and outputs the obtained image to the display device 24.

The vehicle operation system 10 includes a communication section 80, a remote operation information acquisition section 82, a vehicle control section 84, an image processing section 86, and a display output section 88 as the functional components of the second vehicle 16. Each functional configuration is implemented by the CPU 48 of the on-board device 18 reading a vehicle operation program stored in the ROM 50 or the storage 54, and executing the program.

The communication section 80 transmits and receives information to and from another device.

The remote operation information acquisition section 82 controls the communication section 80 to acquire operation information transmitted from the first vehicle 12 via the server 20. The operation information transmitted from the first vehicle 12 is operation information input to the operation interface 30 by the occupant of the first vehicle 12.

The vehicle control section 84 controls the driving of the vehicle drive device 62 based on the various information acquired by the remote operation information acquisition section 82.

The image processing section 86 performs image processing suitable for the display device 24 provided on the first vehicle 12 on the surrounding image of the second vehicle 16 imaged by the image capture device 28, and controls the communication section 80 to transmit the image to the server 20.

The display output section 88 outputs an image of the sign device 26 based on various information acquired by the remote operation information acquisition section 82 (see FIG. 2). In FIG. 2, as an example, an arrow for urging the following vehicle to change lanes is displayed.

The vehicle operation system 10 includes a server control section 90 and a communication section 74 as functional components of the server 20.

The server control section 90 controls the server 20. For example, the server control section 90 acquires the operation information transmitted from the first vehicle 12 and controls the communication section 91 to transmit the operation information to the second vehicle 16. In addition, the server control section 90 acquires the image transmitted from the second vehicle 16 and controls the communication section 91 to transmit the image to the first vehicle 12.

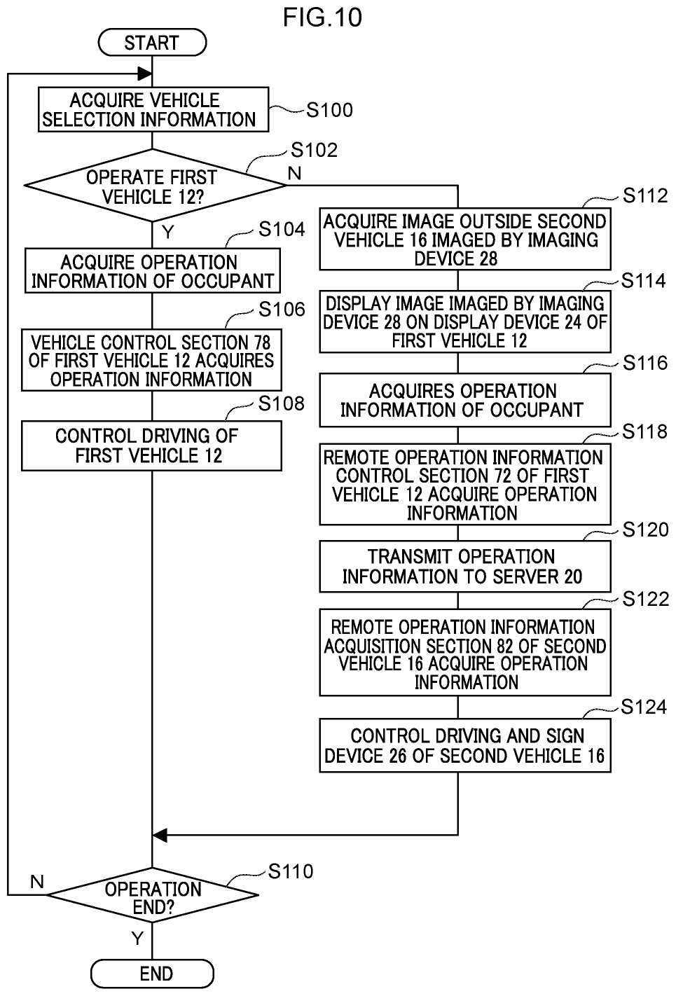

Next, the operation of the vehicle operation system 10 will be described. FIG. 10 is a flowchart illustrating a flow of the operation by the vehicle operation system 10. The CPU 48 in each of the on-board devices 14 and 18 reads out the vehicle operation program from the ROM 50 or the storage 54, and outputs the vehicle operation program to the RAM 52, and executes the vehicle operation program. Further, the CPU 48 in the server 20 reads out the remote operation information distribution program from the ROM 50 or the storage 54, outputs the remote operation information distribution program to the RAM 52, and executes the remote operation information distribution program. Thus, a display process is performed.

The CPU 48 acquires vehicle selection information indicating which vehicle the occupant of the first vehicle 12 wants to operate (step S100). From the acquired vehicle selection information, the CPU 48 determines whether or not the occupant wants to operate the first vehicle 12 (step S102). If the vehicle selection information is for operating the first vehicle 12 (step S102: YES), the CPU 48 acquires operation information from the operation interface 30 of the first vehicle 12 (step S104). Then, the CPU 48 operates the switching control section 70 so that the vehicle control section 78 of the first vehicle 12 acquires the operation information (Step S106). Then, the CPU 48 controls the vehicle drive device 32 of the first vehicle 12 (Step S108).

The CPU 48 determines whether or not the operation has been completed (step S110). When the operation is completed (step S110: YES), the CPU 48 ends the processing based on the vehicle operation program. If the operation is continuing (step S110: NO), the process returns to step S100.

When the vehicle selection information is not for operating the first vehicle 12, that is, when the vehicle selection information is for operating the second vehicle 16 (step S102: NO), the CPU 48 acquires the image outside the second vehicle 16 imaged by the image capturing device 28 of the second vehicle 16 among the plurality of second vehicles 16 which is to be operated (step S112), and the image is displayed on the display device 24 of the first vehicle 12 (see FIG. 5, step S114). Thus, the occupant can operate the operation interface 30 of the first vehicle 12 for remote operation of the second vehicle 16 that the occupant wants to operate while viewing the image in the first vehicle 12.

The CPU 48 acquires operation information from the operation interface 30 of the first vehicle 12 (Step S116). Then, the CPU 48 activates the switching control section 70 so that the remote operation information control section 72 of the first vehicle 12 acquires the operation information (Step S118), and transmits the operation information to the server 20 (Step S120). Thereafter, the CPU 48 causes the remote operation information acquisition section 82 of the second vehicle 16 to be operated to obtain the operation information from the server 20 (step S122), to control the vehicle drive device 62 and the sign device 26 of the second vehicle 16 (step S124). The CPU 48 then transitions to the processing of step S110.

Next, the operation of the first exemplary embodiment will be described.

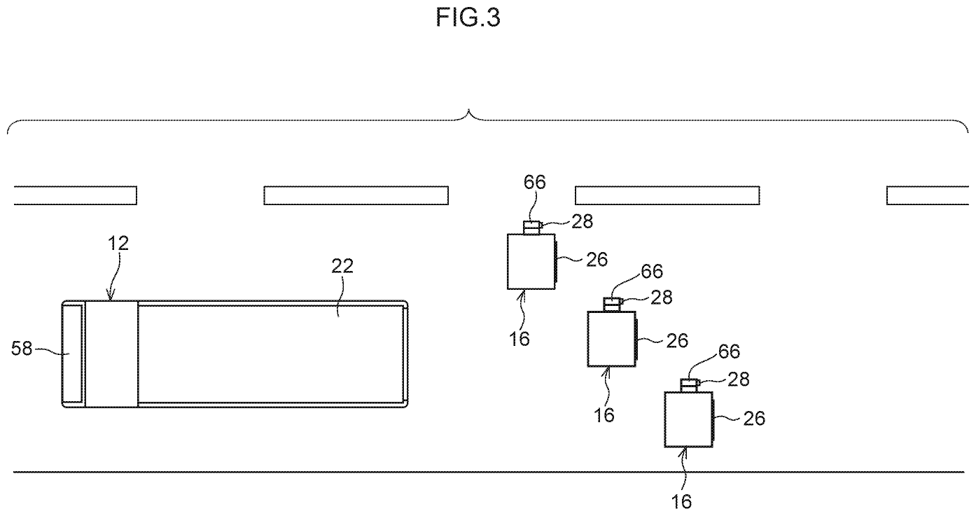

In the present exemplary embodiment, as illustrated in FIG. 1, the second vehicle 16 that can be mounted on the first vehicle 12 can be operated by remote operation by an occupant who has boarded the first vehicle 12. Therefore, after moving with the first vehicle 12 to the site where work is required, it is easy for the occupant of the first vehicle 12 to appropriately operate the second vehicle 16 according to the situation of the site without getting off the first vehicle 12. That is, as illustrated in FIG. 3, the second vehicle 16 provided with the display device 24 can be arranged at an appropriate position according to the work without the occupant getting off at a dangerous place such as on a highway. This remote operation is performed using the operation interface 30 of the first vehicle 12. Therefore, the occupant can remotely operate the second vehicle 16 from the first vehicle 12 without feeling uncomfortable, and can appropriately operate the second vehicle 16. Thus, the second vehicle 16 can be appropriately arranged even under a complicated situation.

As illustrated in FIG. 2, the second vehicle 16 is provided with image capture device 28. The image capture device 28 can photograph the outside of the second vehicle 16. As illustrated in FIG. 5, an image photographed by the image capturing device can be displayed on the front windshield glass 58 of the first vehicle 12 by the display device 24 provided on the first vehicle 12. Therefore, the occupant can remotely operate the second vehicle 16 by the operation interface 30 of the first vehicle 12 in the same posture as when driving the first vehicle 12. Therefore, the cooperation between the driving of the first vehicle 12 and the remote operation of the second vehicle 16 can be smoothly performed. Thereby, workability can be improved.

Further, the image from the image capture device 28 of the second vehicle 16 is output to the front windshield glass 58 of the first vehicle 12 to coincide with a line of sight when viewing from inside the vehicle interior of the first vehicle 12 through the front windshield glass 58 and outside the vehicle. Specifically, the image capture device 28 provided on the second vehicle 16 can be arranged at a position corresponding to the front windshield glass 58 of the first vehicle 12 in the vehicle vertical direction. Therefore, when an image from the image capture device 28 of the second vehicle 16 is displayed on the front windshield glass 58 of the first vehicle 12, an image is displayed that is the same height as the height of the line of sight when viewing from inside the vehicle interior of the first vehicle 12 through the front windshield glass 58 and outside the vehicle. For this reason, the discomfort experienced by the occupant between the image display state and the image non-display state can be reduced. That is, the sense of discomfort when switching from driving the first vehicle 12 to remote operation of the second vehicle 16 can be reduced. Thereby, the present exemplary embodiment can improve operability.

Furthermore, since the display device 24 can display an image on the front side window glass 60 of the first vehicle 12, the image from the image capture device 28 is displayed on the front windshield glass 58 and the front side window glass 60, and by doing so, the occupant performing the remote operation can widely grasp the state outside the second vehicle 16 (see FIG. 5). This makes it easier to grasp the situation outside the vehicle.

In the present exemplary embodiment, one of the plurality of second vehicles 16 that is desired to be operated is operated. The present exemplary embodiment is configured to operate a plurality of second vehicles 16 individually. However, one of the plurality of second vehicles 16 is assigned as the position reference vehicle, and the position reference vehicle is remotely operated by the occupant of the first vehicle 12, and the other second vehicles 16 may be self-propelled or arranged conforming to the second vehicle 16 which is the position reference vehicle.

Further, the second vehicle 16 is configured to be mountable on the cargo bed 22 of the first vehicle 12, but is not limited thereto, and may be configured to be movable integrally with the first vehicle 12 by towing.

### Second Exemplary Embodiment

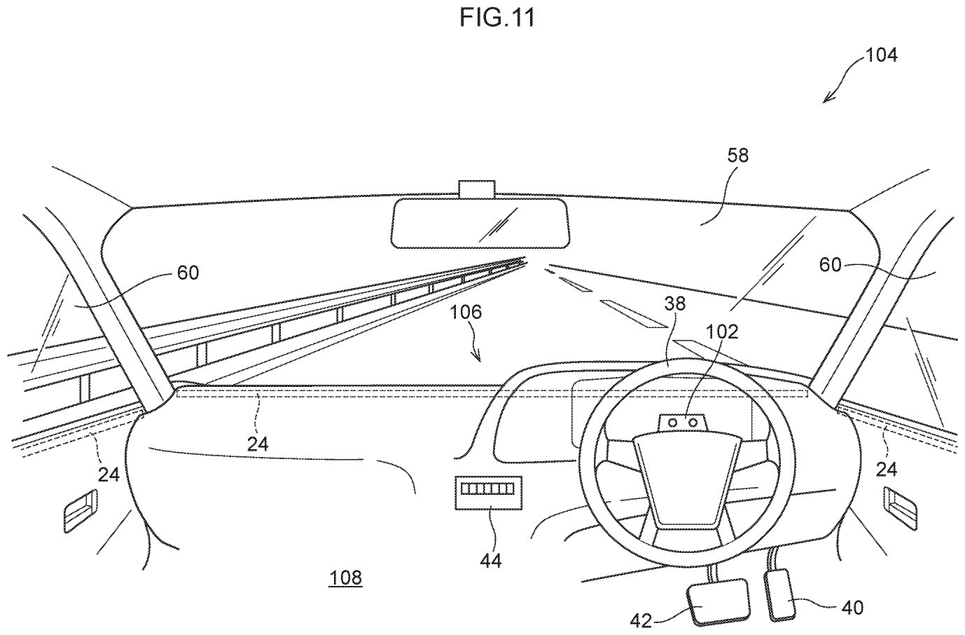

Next, a vehicle operation system according to a second exemplary embodiment of the present disclosure will be described with reference to FIGS. 11 to 13. Component parts that are the same as in the first exemplary embodiment described above are assigned the same reference numerals, and descriptions thereof are not given.

The vehicle operation system 100 according to the second exemplary embodiment has the same basic configuration as that of the first exemplary embodiment, and is characterized in that a line-of-sight detection device 102 is provided.

That is, the first vehicle 104 includes the operation interface 106, the on-board device 112, the vehicle driving device 32, and the display device 24 (see FIG. 6). Each of these components is connected together so as to be capable of mutual communication through a bus 34.

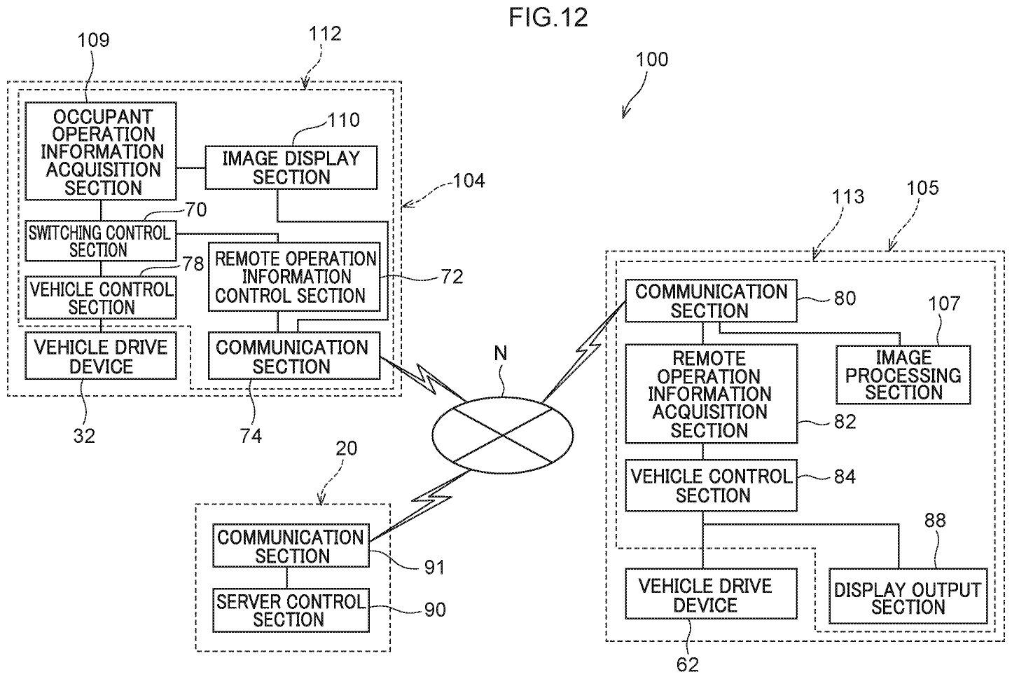

As illustrated in FIG. 11, the operation interface 106 of the first vehicle 104 is arranged on the vehicle front side in the vehicle cabin 108 of the first vehicle 104. The operation interface 106 includes a steering wheel 38, an accelerator pedal 40, a brake pedal 42, a sign display operation device 44, and a line-of-sight detection device 102. The line-of-sight detection device 102 is directed to the head of an occupant sitting in a driver's seat (not illustrated) of the first vehicle 104. The line-of-sight detection device 102 is configured to be able to detect the line-of-sight direction of the occupant. The operation interface 106 is connected to an occupant operation information acquisition section 109 described later in the on-board device 112 (see FIG. 12).

The on-board device 112 includes a CPU 48, a ROM 50, a RAM 52, a storage 54, and a communication interface 56 (see FIG. 6). Each of these components is connected together so as to be capable of mutual communication through a bus 34.

The second vehicle 105 includes an on-board device 113, a vehicle driving device 62, an image capture device 28, and a sign device 26 (see FIG. 7). The on-board device 113 includes a CPU 48, a ROM 50, a RAM 52, a storage 54, and a communication interface 56, similarly to the on-board device 112 (see FIG. 7). Each of these components is connected together so as to be capable of mutual communication through a bus 34.

As illustrated in FIG. 12, the vehicle operation system 100 includes, as functional components in the first vehicle 104, an occupant operation information acquisition section 109, a switching control section 70, a remote operation information control section 72, a communication section 74, a vehicle control section 78 and an image display section 110. Each functional component is implemented by the CPU 48 of the on-board device 112 reading a vehicle operation program stored in the ROM 50 or the storage 54, and executing the program.

The occupant operation information acquisition section 109 obtains operation information and line-of-sight direction input to the operation interface 106 by the occupant of the first vehicle 104.

The vehicle operation system 100 includes a communication section 80, a remote operation information acquisition section 82, a vehicle control section 84, an image processing section 107, and a display output section 88 as the functional components of the second vehicle 105. Each functional component is implemented by the CPU 48 of the on-board device 113 reading a vehicle operation program stored in the ROM 50 or the storage 54, and executing the program.

The image processing section 107 provided in the second vehicle 105 carries out image processing so as to correspond the surrounding image of the second vehicle 105 imaged by the image capturing device 28 to the line-of-sight direction acquired by the occupant operation information acquisition section 109 and makes it compatible with the display device 24 provided in the first vehicle 104.

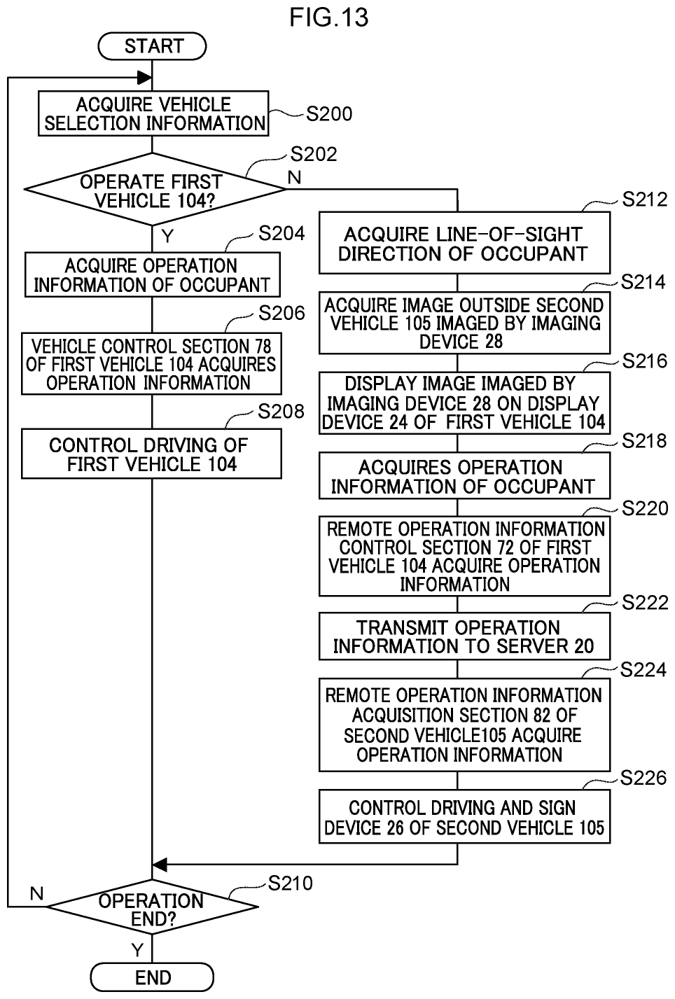

Next, the operation of the vehicle operation system 100 will be described. FIG. 13 is a flowchart illustrating a flow of the operation by the vehicle operation system 10. The CPU 48 of each of the on-board devices 112 and 113 reads out the vehicle operation program from the ROM 50 or the storage 54, and outputs and executes the vehicle operation program on the RAM 52. The CPU 48 of the server 20 reads out the remote operation information distribution program from the ROM 50 or the storage 54, outputs the remote operation information distribution program to the RAM 52, and executes the remote operation information distribution program. Thus, a display process is performed.

The CPU 48 acquires vehicle selection information indicating which vehicle the occupant of the first vehicle 104 wants to operate (step S200). From the acquired vehicle selection information, the CPU 48 determines whether or not the occupant wants to operate the first vehicle 104 (step S202). If the vehicle selection information is for operating the first vehicle 104 (step S202: YES), the CPU 48 acquires operation information from the operation interface 106 of the first vehicle 104 (step S204). Then, the CPU 48 activates the switching control section 70 to transmit the operation information to the vehicle control section 78 of the first vehicle 104, such that the vehicle control section 78 of the first vehicle 104 acquires the operation information (Step S206). Then, the CPU 48 controls the vehicle drive device 32 of the first vehicle 104 (Step S208).

The CPU 48 determines whether or not the operation has been completed (step S210). When the operation is completed (step S210: YES), the CPU 48 ends the processing based on the vehicle operation program. If the operation is continuing (step S210: NO), the process returns to step S200.

If the vehicle selection information is not for operating the first vehicle 104, that is, if the vehicle selection information is for operating the second vehicle 105 (step S202: NO), the CPU 48 acquires the line-of-sight direction of the occupant (step S212), acquires the image outside the second vehicle 105 imaged by the image capturing device 28 (step S214), and causes display of the image on the display device 24 of the first vehicle 104 (step S216). Thus, the occupant can operate the operation interface 106 of the first vehicle 104 for remote operation of the second vehicle 105 while viewing the image in the first vehicle 104.

The CPU 48 acquires operation information from the operation interface 106 of the first vehicle 104 (Step S218). Then, the CPU 48 activates the switching control section 70 so that the remote operation information control section 72 of the first vehicle 104 acquires the operation information (Step S220), and transmits the operation information to the server 20 (Step S222). Thereafter, the CPU 48 causes the remote operation information acquisition section 82 of the second vehicle 105 to obtain the operation information (step S224), to control the vehicle drive device 62 and the sign device 26 of the second vehicle 105 (step S226). The CPU 48 then transitions to the processing of step S210.

Next, the operation of the second exemplary embodiment will be described.

Even with the above configuration, the configuration is the same as that of the vehicle operation system 10 of the first exemplary embodiment except that the line-of-sight detection device 102 is provided, and thus the same effects as those of the first exemplary embodiment can be obtained. Further, the first vehicle 104 is provided with a line-of-sight detection device 102. On the display device 24, an image corresponding to the position of the line of sight of the occupant detected by the line-of-sight detection device 102 is displayed. From this, it is possible to alleviate a sense of discomfort due to a difference in the position of the line of sight between the case where the outside of the vehicle is viewed through the front windshield glass 58 from inside the vehicle cabin 108 of the first vehicle 104 and the case where the image is viewed. Therefore, it is possible to appropriately operate the second vehicle 105 while reducing a sense of discomfort at the time of remote control. Thereby, the present exemplary embodiment can improve operability.

### Third Exemplary Embodiment

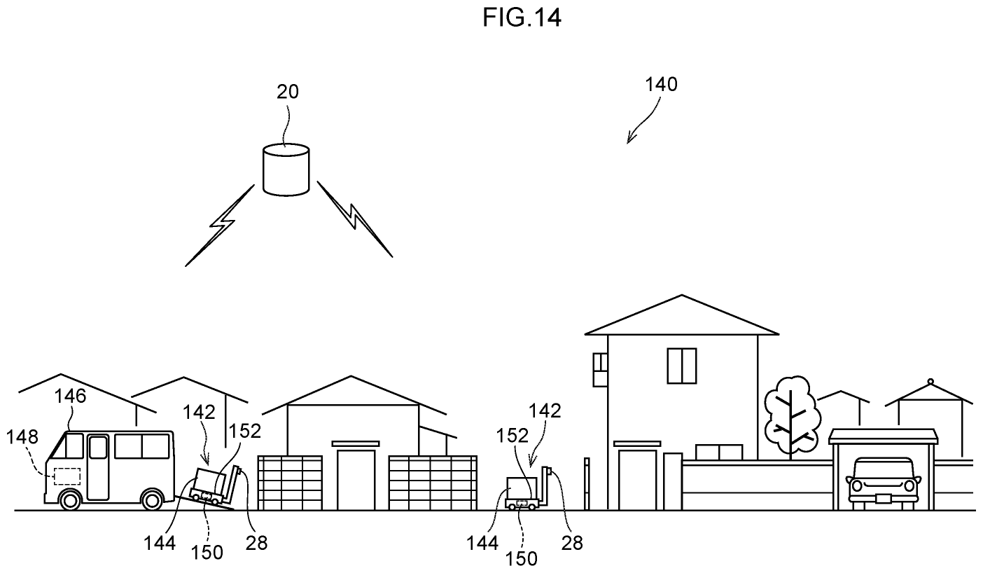

Next, a vehicle operation system according to a third exemplary embodiment of the present disclosure will be described with reference to FIGS. 14 to 16. Component parts that are the same as in the first exemplary embodiment described above are assigned the same reference numerals, and descriptions thereof are not given.

The vehicle operation system 140 according to the third exemplary embodiment has a basic configuration similar to that of the first exemplary embodiment, and is characterized in that the second vehicle 142 is a work vehicle capable of carrying luggage 144.

That is, as illustrated in FIG. 14, the vehicle operation system 140 is configured including a first vehicle 146, an on-board device 148 mounted on the first vehicle 146, a plurality of second vehicles 142, on-board devices 150 mounted on each of the second vehicles 142, and a server 20. These on-board devices 148 and 150 and the server 20 are communicably connected via a network that is not illustrated.

The first vehicle 146 includes, for example, an operation interface 30, a vehicle driving device 32, and a display device 24, which are communicably connected to each other via a bus (not illustrated). In addition, the first vehicle 146 is, for example, a vehicle for a delivery company having a luggage room, and a plurality of second vehicles 142 can be mounted in the luggage room. This first vehicle 146 is operated by manual driving by an occupant (not illustrated) in the passenger compartment, and has an operation interface 30, an on-board device 148, a vehicle driving device 32, and a display device 24 (see FIG. 6). Each of these components is connected together so as to be capable of mutual communication through a bus 34.

The on-board device 148 transmits operation information of the first vehicle 146 to the server 20 provided outside the vehicle. The on-board device 148 is configured including a CPU 48, a ROM 50, a RAM 52, a storage 54, and a communication interface 56 (see FIG. 6). Each of these components is connected together so as to be capable of mutual communication through a bus 34.

The second vehicle 142 is, for example, a small vehicle including the luggage mounting section 152 and the image capture device 28. After the second vehicle 142 is mounted on the first vehicle 146 and moves to a predetermined location, the second vehicle 142 is lowered from the first vehicle 146 and remote operation by occupants of the first vehicle 146 is possible in an area where the road width is relatively narrow, such as a dense residential area. That is, in the present exemplary embodiment, the second vehicle 142 is a work support vehicle having a load carrying function.

The luggage 144 can be placed on the upper surface of the luggage mounting section 152, and the luggage mounting section 152 has a luggage holding mechanism (not illustrated). The luggage mounting section 152 can hold and not hold the luggage 144 based on operation information received from the first vehicle 146 via the server 20.

The on-board device 150 transmits an image from the image capture device 28 of the mounted second vehicle 142 to the server 20 and acquires remote operation information from the server 20. The on-board device 150 includes a CPU 48, a ROM 50, a RAM 52, a storage 54, and a communication interface 56, similarly to the on-board device 148 (see FIG. 7). Each of these components is connected together so as to be capable of mutual communication through a bus 34. In addition, the operation information described above includes the rotation angle of the steering wheel for operating each of the first vehicle 146 and the second vehicle 142, the depression amount of the accelerator pedal and the brake pedal, vehicle selection information indicating which of the first vehicle 146 and the second vehicle 142 is to be operated, and information for operating the luggage holding structure of the second vehicle 142. In addition, among the operation information, information for operating the second vehicle 142 is particularly referred to as remote operation information.

When executing the above-mentioned vehicle operation program, the vehicle operation system 140 realizes various functions using the above-mentioned hardware resources. Explanation follows regarding the functional configurations realized by the vehicle operation system 140.

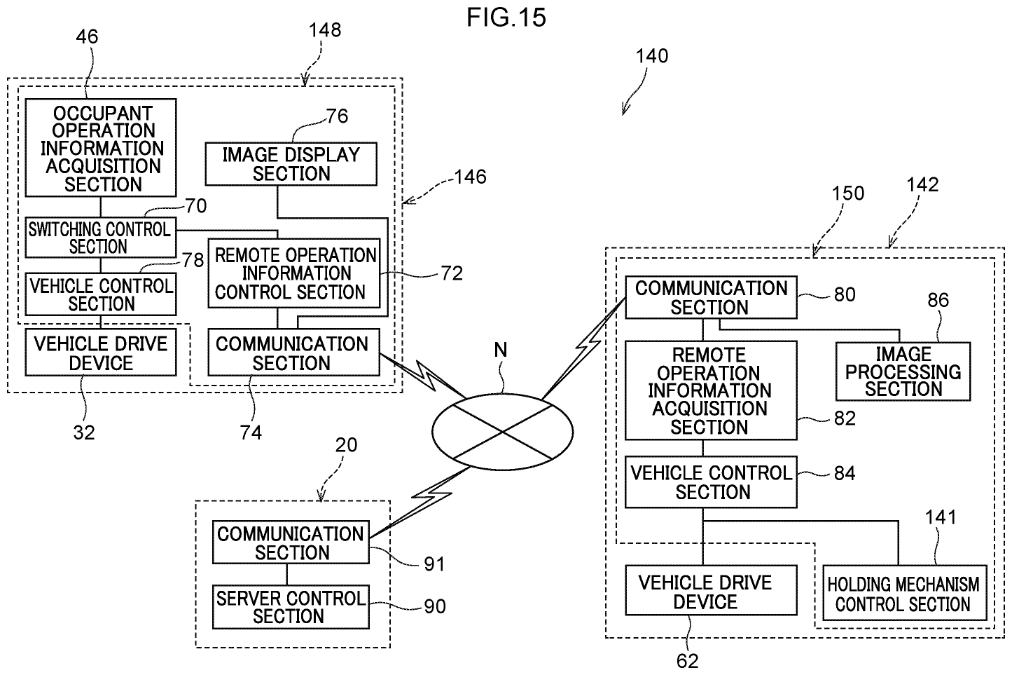

FIG. 15 is a block diagram illustrating an example of a functional configuration of the vehicle operation system 140.

As illustrated in FIG. 15, the vehicle operation system 140 includes, as functional components in the first vehicle 146, an occupant operation information acquisition section 46, a switching control section 70, a remote operation information control section 72, a communication section 74 and an image display section 76. Each functional component is implemented by the CPU 48 of the on-board device 148 reading a vehicle operation program stored in the ROM 50 or the storage 54, and executing the program.

The vehicle operation system 140 includes a communication section 80, a remote operation information acquisition section 82, a vehicle control section 84, an image processing section 86, and a holding mechanism control section 141 as the functional components of the second vehicle 142. Each functional component is implemented by the CPU 48 of the on-board device 150 reading a vehicle operation program stored in the ROM 50 or the storage 54, and executing the program.

The holding mechanism control section 141 controls the luggage holding mechanism in the luggage mounting section 152 of the second vehicle 142 based on the operation information transmitted from the first vehicle 146 via the server 20.

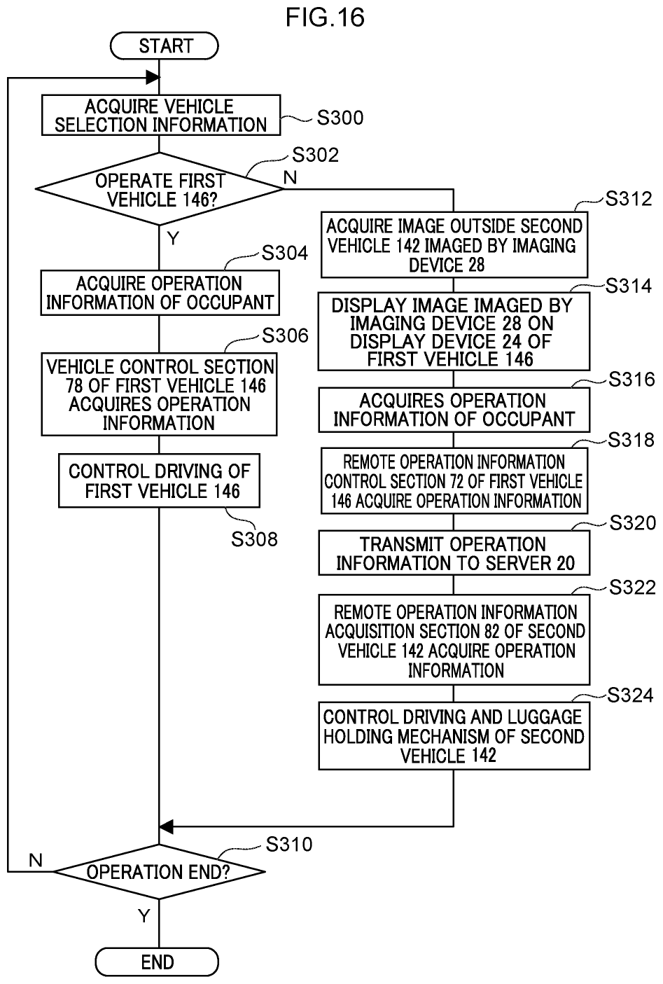

Next, the operation of the vehicle operation system 140 will be described. FIG. 16 is a flowchart illustrating a flow of the operation by the vehicle operation system 10. The CPU 48 of each of the on-board devices 148 and 150 reads out the vehicle operation program from the ROM 50 or the storage 54, and outputs the vehicle operation program to the RAM 52, and executes the vehicle operation program. The CPU 48 of the server 20 reads out the remote operation information distribution program from the ROM 50 or the storage 54, outputs the remote operation information distribution program to the RAM 52, and executes the remote operation information distribution program. Thus, a display process is performed.

The CPU 48 acquires vehicle selection information indicating which vehicle the occupant of the first vehicle 146 wants to operate (step S300). From the acquired vehicle selection information, the CPU 48 determines whether or not the occupant wants to operate the first vehicle 146 (step S302). If the vehicle selection information is for operating the first vehicle 146 (step S302: YES), the CPU 48 acquires operation information from the operation interface 30 of the first vehicle 146 (step S304). Then, the CPU 48 operates the switching control section 70 so that the vehicle control section 78 of the first vehicle 146 acquires the operation information (Step S306). Then, the CPU 48 controls the vehicle drive device 32 of the first vehicle 146 (Step S308).

The CPU 48 determines whether or not the operation has been completed (step S310). When the operation is completed (step S310: YES), the CPU 48 ends the processing based on the vehicle operation program. If the operation is continuing (step S310: NO), the process returns to step S300.

If the vehicle selection information is not for operating the first vehicle 146, that is, if the vehicle selection information is for operating the second vehicle 142 (step S302: NO), the CPU 48 acquires the image outside the second vehicle 142 imaged by the image capturing device 28 (step S312), and causes display of the image on the display device 24 of the first vehicle 146 (step S314). Thus, the occupant can operate the operation interface 30 of the first vehicle 146 for remote operation of the second vehicle 142 while viewing the image in the first vehicle 146.

The CPU 48 acquires operation information from the operation interface 30 of the first vehicle 146 (Step S316). Then, the CPU 48 activates the switching control section 70 so that the remote operation information control section 72 of the first vehicle 146 acquires the operation information (Step S318), and transmits the operation information to the server 20 (Step S320). Thereafter, the CPU 48 causes the remote operation information acquisition section 82 of the second vehicle 142 to obtain the operation information (step S322), to control the vehicle drive device 62 and the luggage holding mechanism of the second vehicle 142 (step S324). The CPU 48 then transitions to the processing of step S310.

Next, the operation of the third exemplary embodiment will be described.

According to the above-described configuration, since the third exemplary embodiment is the same as the vehicle operation system 10 of the first exemplary embodiment except that the second vehicle 142 is a work vehicle capable of transporting the luggage 144, the same effect as the first exemplary embodiment can be obtained. Further, since the second vehicle 142 is a work vehicle capable of transporting the luggage 144, the luggage 144 can be transported to a predetermined place even in an area that is difficult for large vehicles to enter, such as a dense residential area. Further, since the second vehicle 142 carries the luggage by remote control without the occupant of the first vehicle 146 getting off, the work load on the occupant can be reduced. Further, the second vehicle 142 can be appropriately driven on a residential road or the like having many irregular elements as compared with an automobile exclusive road or the like without using advanced automatic driving technology. As a result, labor shortage in work can be eliminated while suppressing an increase in the introduction cost.

In the third exemplary embodiment described above, the second vehicle 142 is a vehicle capable of transporting the luggage 144, but is not limited to this, and may be a vehicle that performs other work such as a work vehicle that collects garbage.

Further, in the above-described first to third exemplary embodiments, the image capture device 28 can be arranged at a position corresponding to the front windshield glass 58 in the first vehicles 12, 146 in the vehicle vertical direction. However, the present disclosure is not limited to this. A image capturing device may be provided in the main body of the second vehicle 16, 142, and image processing may process and output a processed image by extracting a part of an image output from the image capturing device such that the processed image shows a state when looked from a height that is the same as the line of sight when viewing the outside through the front windshield glass 58 from the vehicle interior of the first vehicle 12, 146. Further, other configurations may be adopted.

Although exemplary embodiments of the present disclosure have been described above, the present disclosure is not limited to the above, and, of course, may be implemented by being modified in various ways other than the above within a scope that does not depart from the gist thereof.

What is claimed is:

1. A vehicle operation system, comprising:
a first vehicle in which an occupant boards; and
a second vehicle configured to be loaded on or towed by the first vehicle and supports plural kinds of work, the second vehicle being remotely operable by remote operation by the occupant using an operation interface of the first vehicle.

2. The vehicle operation system according to claim 1, wherein:
the second vehicle includes an image capturing device configured to image vehicle surroundings of the second vehicle; and
the first vehicle includes a display device configured to display an image imaged by the image capturing device at a front windshield glass.

3. The vehicle operation system according to claim 2, wherein the image displayed at the display device is displayed to coincide with a line-of-sight when viewing surroundings from a vehicle interior of the first vehicle through the front windshield glass.

4. The vehicle operation system according to claim 3, wherein the image capturing device can be positioned at a vehicle vertical direction that corresponds to the front windshield glass of the first vehicle.

5. The vehicle operation system according to claim 2, wherein the display device displays the image at a side window glass of the first vehicle.

6. The vehicle operation system according to claim 2, wherein:
the first vehicle is configured to detect a line-of-sight of the occupant; and
an image corresponding to a line-of-sight of the occupant detected by the line-of-sight detection device is displayed at the display device.
